(19) United States
(12) Patent Application Publication
(10) Pub. No.: US 2007/0037584 A1
(43) Pub. Date: Feb. 15, 2007

(54) Method for triggering handover of mobile terminal and system thereof

(75) Inventor: Koo-Hyun Um, Seoul (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/500,432

(22) Filed: Aug. 8, 2006

(30) Foreign Application Priority Data
Aug. 9, 2005 (KR) 10-2005-0072921

(51) Int. Cl. H04Q 7/20

(52) U.S. Cl. 455/456.1; 455/436

(57) ABSTRACT

A mobile terminal and method for performing handover, are discussed. According to an embodiment, the method includes calculating a distance value between a mobile terminal and each of a plurality of neighbor base stations based on power values of the plurality of neighbor base stations; and transmitting information of a specific neighbor base station corresponding to the shortest distance value among the calculated distance values, to a serving base station.

This application claims the priority benefit of the Korean Patent Application No. 10-2005-0072921, filed on Aug. 9, 2005, which is hereby incorporated by reference as if fully set forth herein.

### BACKGROUND OF THE INVENTION

1. Field of the Invention

The present invention relates to a mobile terminal and, more particularly, to a method for triggering handover of a mobile terminal and its system.

2. Description of the Related Art

A mobile terminal, which employs a universal mobile telecommunications system (UMTS) and a wideband code division multiple access (WCDMA) technique, performs handover when signal strength weakens. Herein, handover refers to a function of, when the mobile terminal in a call communication state moves out of a pertinent base station service area (cell boundary) and moves into a neighbor base station service area, keeping the call state by being automatically tuned with a new traffic channel of the neighbor base station. That is, the mobile terminal wirelessly linked to the serving base station is wirelessly linked to a neighbor base station when signal strength of the serving base station becomes weak.

FIG. 1 shows a method for performing handover of a mobile terminal in accordance with the related art.

As shown in FIG. 1, when signal strength of the serving base station becomes weak so a handover event occurs, the mobile terminal receives a message for handover from the serving base station. For example, when the handover event occurs as the mobile terminal in a call communication state moves out of a cell boundary of a first base station and moves into a service boundary of a second base station, the serving base station transmits a NBR-ADV (neighbor advertisement) message including information regarding a plurality of neighbor base stations to the mobile terminal.

Then, the mobile terminal transmits a SCN-REQ (scanning interval request) message based on the NBR-ADV message to the serving base station to thereby determine a handover available base station.

However, in the related art method for triggering handover of the mobile terminal, the serving base station informs the mobile terminal about the plurality of neighbor base stations one-sidedly. Specifically, the serving base station transmits information regarding the plurality of neighbor base stations to the mobile terminal through the NBR-ADV message, and the mobile terminal determines a handover available base station by transmitting the SCN-REQ message to the serving base station. Namely, since the mobile terminal receives information of the plurality of neighbor base stations from the serving base station, time for scanning the information on the plurality of neighbor base stations for handover is lengthened.

Thus, the related art method for triggering handover of the mobile terminal has a problem that since time for scanning the information of the plurality of neighbor base stations is lengthened, handover cannot be quickly performed.

U.S. Pat. Nos. 6,615,044, 6,845,238 and 6,879,831 also disclose related art handover methods.

### SUMMARY OF THE INVENTION

Therefore, an object of the present invention is to provide a method and apparatus for triggering handover of a mobile terminal capable of quickly performing handover by reducing time required for scanning information of neighbor base stations when a handover event of a mobile terminal occurs.

Another object of the present invention is to provide a mobile terminal and method for performing handover, which address the limitations and disadvantages associated with the related art.

To achieve at least the above objects in whole or in parts, according to an embodiment there is provided a method for triggering a communication event of a mobile terminal, comprising: calculating a distance value between a mobile terminal and each of a plurality of neighbor base stations based on power values of the plurality of neighbor base stations; and transmitting information of a specific neighbor base station corresponding to the shortest distance value among the calculated distance values, to a serving base station.

To achieve at least these advantages in whole or in parts, according to another embodiment there is further provided a method for triggering handover of a mobile terminal, comprising: determining a power value of each of a plurality of neighbor base stations when a handover event of a mobile terminal occurs; calculating a distance value between the mobile terminal and each of the plurality of neighbor base stations based on the determined power values; and transmitting information of at least one specific neighbor base station having the calculated distance value less than a reference distance value among the calculated distance values, to a serving base station.

To achieve at least these advantages in whole or in parts, according to another embodiment there is further provided a method for triggering handover of a mobile terminal, comprising: receiving signals of neighbor base stations adjacent to a mobile terminal in response to an occurrence of a handover event when the handover event occurs based on signal strength between the mobile terminal and the base stations; calculating a distance value between the mobile terminal and each of the neighbor base stations based on the received signals; comparing the calculated distance values with a reference distance value; and registering information of a specific adjacent base station corresponding to the calculated distance value shorter than the reference distance value for handover.

To achieve at least these advantages in whole or in parts, according to another embodiment there is further provided a mobile terminal comprising: a physical layer for receiving signals from neighbor base stations when a handover event of the mobile terminal occurs and measuring a power value of each received signal; a radio link control (RLC) layer for transmitting a message for handover to a serving base station; and a control layer for calculating a distance value between the mobile terminal and each of the neighbor base stations based on the power values measured by the physical layer and registering information of at least one neighbor base station having the calculated distance value shorter than a reference distance value among the calculated distance values in a message for handover.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a view showing a method for triggering handover of a mobile terminal in accordance with a related art;

FIG. 2 is a view showing a system for explaining a method for triggering handover of a mobile terminal in accordance with the present invention;

FIG. 3 is a schematic block diagram showing the construction of an apparatus for triggering handover of a mobile terminal in accordance with the present invention; and

FIG. 4 is a flow chart illustrating the processes of a method for triggering handover of a mobile terminal in accordance with the present invention.

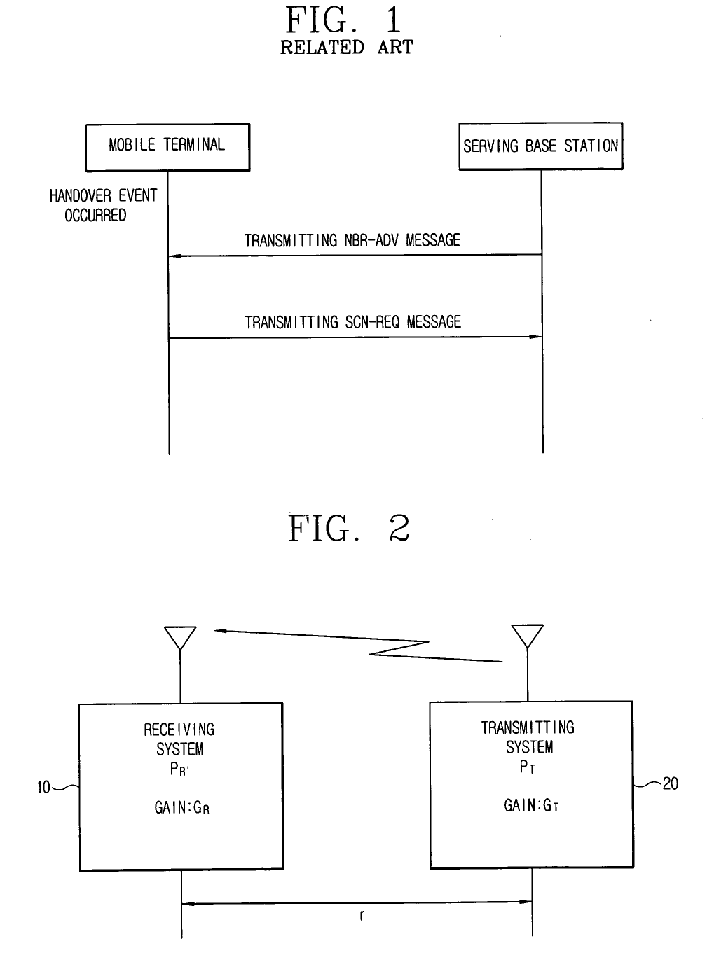

### DETAILED DESCRIPTION OF THE PREFERRED EMBODIMENTS

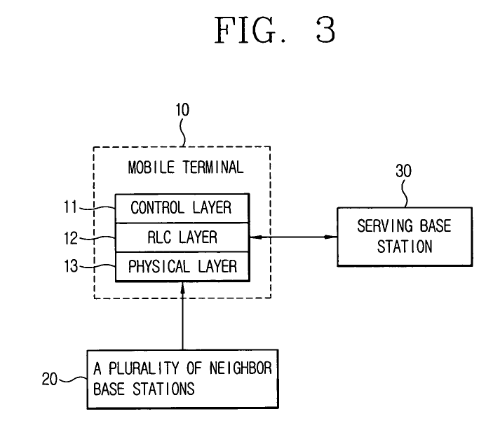

A method for quickly performing handover by reducing time required for scanning based on signal strength (power value) of neighbor base stations when a communication-handover event of a mobile terminal occurs in accordance with the present invention will now be described with reference to FIGS. 2 to 4. Herein, the mobile terminal can be applied for a universal mobile telecommunications system (UMTS) and a wideband code division multiple access (WCDMA) system.

FIG. 2 is a view showing a system for explaining a method for triggering handover of a mobile terminal in accordance with the present invention. The mobile terminal can be a cellular phone, a smart phone, etc.

As shown in FIG. 2, a mobile terminal 10 calculates a power value (PR) received from a neighbor base station 20 through equation (1) shown below:

$${P}_{R} = {[ \frac{λ}{4 π r} ]}^{2} {P}_{T} \cdot {G}_{T} \cdot {G}_{R} \qquad ( 1 )$$

wherein P_{T} is transmission power of the neighbor station 20, G_{T} is a transmitting antenna gain of the neighbor base station 20 and G_{R} is a receiving antenna gain of the mobile terminal 10.

Accordingly, the mobile terminal 10 can calculate a distance (r) between the mobile terminal itself and the neighbor base station 20 through equation (2) shown below:

$$r = \frac{λ}{4 π} \cdot \sqrt{\frac{{P}_{T} \cdot {G}_{T} \cdot {G}_{R}}{{P}_{R}}} \qquad ( 2 )$$

The mobile terminal 10 receives signals from a plurality of adjacent base stations, but registers only information of those neighbor base stations corresponding to ‘r’ values smaller than a reference distance value (e.g., 1.5 km) in a message for handover (e.g., N_NEIGHBORS of MOB_NBR-ADV). Accordingly, the number of neighbor base stations to be scanned is limited according to each signal strength of the plurality of neighbor base stations or each distance value. As a result, the present invention reduces the time required for scanning the information of the neighbor base stations and thus quickly performs handover.

In the present invention, the mobile terminal calculates a distance between the mobile terminal itself and each of the neighbor base stations, e.g., using the equation (2) above, and registers only those neighbor base stations that are close to the mobile terminal by a pre-set number (e.g., information of a neighbor base station having the shortest distance value), to thereby quickly perform handover.

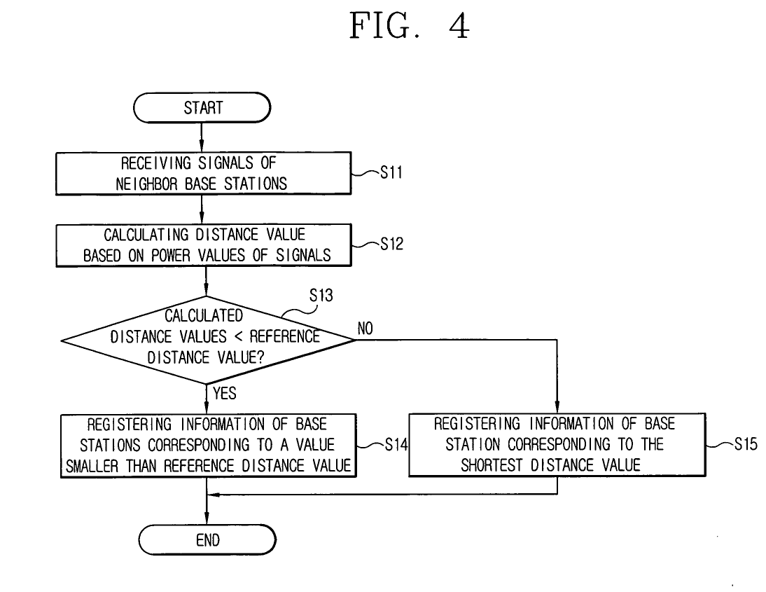

FIG. 3 is a schematic block diagram showing the construction of an apparatus for triggering handover of a mobile terminal in accordance with an embodiment of the present invention.

As shown in FIG. 3, the apparatus for triggering handover of a mobile terminal includes a physical layer 13 for receiving signals from a plurality of neighbor base station when a handover event occurs, and measuring power values of the received signals; a radio link control (RLC) layer 12 for transmitting a message for handover to a serving base station 30; and a control layer 11 for calculating a distance between the mobile terminal 10 and each of the neighbor base stations 20 based on the power values measured by the physical layer 13, and registering information of only the one or more neighbor base stations each having a value of distance shorter than a reference distance value among the calculated distance values, in the message for handover. Herein, the RLC layer 12 transmits the registered information of the selected neighbor base stations to the serving base station 30 through the message for handover. The mobile terminal 10 includes the layers 11-13 and other components.

The operation of the apparatus for triggering handover of the mobile terminal in accordance with an embodiment of the present invention will now be described in detail with reference to FIG. 4.

FIG. 4 is a flow chart illustrating the processes of a method for triggering handover of a mobile terminal in accordance with the present invention. Herein, the handover refers to soft handover.

As shown in FIG. 4, the method for triggering handover of a mobile terminal in accordance with an embodiment of the present invention includes receiving, by the mobile terminal, signals from a plurality of neighbor base stations when a handover event occurs based on each signal strength between the mobile terminal and base stations; measuring a power value of each received signal and calculating a distance between the mobile terminal and each neighbor base station based on each measured power value; comparing each of the calculated distance values with a reference distance value and registering information of neighbor base stations corresponding to values of distances shorter than the reference distance value among the calculated distance values in a message for handover (e.g., an SCN-REQ (Scanning Interval Allocation Request) message; and determining a base station to which the mobile terminal can perform handover by transmitting the message for handover to a serving base station.

Herein, it is preferred that the number of neighbor base stations having the values of shorter distances is previously set.

The method for triggering handover of a mobile terminal in accordance with the present invention will now be described with reference to FIGS. 3 and 4.

First, when a handover event occurs as signal strength between the mobile terminal 10 and the serving base station 30 becomes weak, the physical layer 13 of the mobile terminal receives signals from the plurality of neighbor base stations 20, measures power of each received signal, and transmits the measured power values to the control layer 11. For example, when the handover event occurs as the mobile terminal 10 in a call state moves out of a service area (cell boundary) of a first base station and moves into a service area of a second base station, the physical layer 13 receives a signal of the second base station and measures power of the received signal (step S11).

Herein, the second base station is at least one or more base stations, and handover refers to a function in which when the mobile terminal in a call communication state moves out of a pertinent base station service area (cell boundary) into a neighbor base station service area, and signal strength between the pertinent base station and the mobile terminal becomes weak, so in order to maintain the call, the mobile terminal is automatically tuned with a new traffic channel of the neighbor base station. Namely, the mobile terminal is wirelessly linked with a neighbor base station in order to maintain the communication link.

Thereafter, the control layer 11 of the mobile terminal 10 receives power values of the plurality of neighbor base stations, calculates a distance value between the mobile terminal 10 itself and each neighbor base station by substituting the received power values to the above-stated equation (2), and determines whether each calculated distance value is smaller than a pre-set reference distance value (steps S12 & S13).

If one or more of the calculated distance values are determined to be smaller than the pre-set reference distance value (step S13), the control layer 11 of the mobile terminal 10 registers information of neighbor base stations each having a value of a distance shorter than the pre-set reference distance value in a message for handover (step S14). Herein, according to one preferred embodiment the mobile terminal 10 registers only information of a neighbor base station having the shortest distance value among the calculated distance values that are less than the pre-set reference distance value, in the message for handover.

If, however, the calculated distance values are greater than (or equal to) the pre-set reference distance value at step S13, it is preferred that the control layer 11 of the mobile terminal 10 registers information of a neighbor base station having the shortest calculated distance value among all the calculated distance values, in a message for handover (step S15).

The mobile terminal 10 determines a handover available base station (e.g., a base station corresponding to the shortest calculated distance value) by transmitting the message for handover having the information of the neighbor base station to the serving base station 30. Accordingly, the mobile terminal 10 releases the radio link with the previous serving base station and wirelessly links with the selected neighbor base station (e.g., base station having the shortest calculated distance value).

As so far described, the method and apparatus for triggering handover of the mobile terminal in accordance with the present invention have many advantages.

For example, when the handover event of the mobile terminal occurs, the serving base station does not transmit all the information of the plurality of neighbor base stations to the mobile terminal, but the mobile terminal receives signals from the plurality of neighbor base stations and registers only the information of the most adjacent base station(s) to thereby shorten the time required for searching and scanning the information of the neighbor base stations. For example, by reducing the number of neighbor base stations to be scanned based on the power values of the neighbor base stations, the time taken for scanning the neighbor base stations can be shortened.

In addition, since the time taken for scanning the information of the neighbor base stations is reduced, handover can be quickly performed.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A method for triggering a communication event of a mobile terminal, the method comprising:
calculating a distance value between a mobile terminal and each of a plurality of neighbor base stations based on power values of the plurality of neighbor base stations; and
transmitting information of a specific neighbor base station corresponding to the shortest distance value among the calculated distance values, to a serving base station.

2. The method of claim 1, wherein the information of the specific neighbor base station is registered in a message for handover.

3. The method of claim 2, wherein the message including the information of the specific neighbor base station is transmitted to a serving base station.

4. The method of claim 2, wherein the handover is a soft handover event.

5. A method for triggering handover of a mobile terminal, the method comprising:
determining a power value of each of a plurality of neighbor base stations when a handover event of a mobile terminal occurs;
calculating a distance value between the mobile terminal and each of the plurality of neighbor base stations based on the determined power values; and
transmitting information of at least one specific neighbor base station having the calculated distance value less than a reference distance value among the calculated distance values, to a serving base station.

6. The method of claim 5, wherein the information of the at least one specific neighbor base station is registered in a message for handover.

7. The method of claim 6, wherein the message includes information of a single neighbor base station.

8. The method of claim 6, wherein the message includes information of at least two neighbor base stations.

9. The method of claim 6, wherein the message includes information of a neighbor base station having the shortest distance value, among the calculated distance values less than the reference distance value.

10. The method of claim 5, wherein the handover event is a soft handover event.

11. The method of claim 5, wherein in the calculating step, the distance value (r) between the mobile terminal and each of the neighbor base stations is calculated by an equation shown below:
$$r = \frac{λ}{4 π} \cdot \sqrt{\frac{{P}_{T} \cdot {G}_{T} \cdot {G}_{R}}{{P}_{R}}}$$
wherein P_{T} is transmission power of a corresponding neighbor base station, G_{T} is a transmitting antenna gain of the corresponding neighbor base station, G_{R} is a receiving antenna gain of the mobile terminal.

12. A method for triggering handover of a mobile terminal, the method comprising:
receiving signals of neighbor base stations adjacent to a mobile terminal in response to an occurrence of a handover event when the handover event occurs based on signal strength between the mobile terminal and the base stations;
calculating a distance value between the mobile terminal and each of the neighbor base stations based on the received signals;
comparing the calculated distance values with a reference distance value; and
registering information of a specific adjacent base station corresponding to the calculated distance value shorter than the reference distance value for handover.

13. The method of claim 12, wherein, in the step of registering the information of the specific neighbor base station, information of a neighbor base station corresponding to the shortest distance value, among the calculated distance values shorter than the reference distance value, is registered in a message for the handover.

14. The method of claim 12, wherein in the calculating step, the distance value (r) between the mobile terminal and each of the neighbor base stations is calculated by an equation shown below:
$$r = \frac{λ}{4 π} \cdot \sqrt{\frac{{P}_{T} \cdot {G}_{T} \cdot {G}_{R}}{{P}_{R}}}$$
wherein P_{T} is transmission power of a corresponding neighbor base station, G_{T} is a transmitting antenna gain of the corresponding neighbor base station, and G_{R} is a receiving antenna gain of the mobile terminal.

15. The method of claim 12, wherein the handover is soft handover.

16. A mobile terminal comprising:
a physical layer for receiving signals from neighbor base stations when a handover event of the mobile terminal occurs and measuring a power value of each received signal;
a radio link control (RLC) layer for transmitting a message for handover to a serving base station; and
a control layer for calculating a distance value between the mobile terminal and each of the neighbor base stations based on the power values measured by the physical layer, and registering information of at least one neighbor base station having the calculated distance value shorter than a reference distance value among the calculated distance values in a message for handover.

17. The mobile terminal of claim 16, wherein the control layer registers information of a neighbor base station corresponding to the shortest calculated distance value among the calculated distance values shorter than the reference distance value in the message.

18. The mobile terminal of claim 17, wherein the RLC layer transmits the message including the information of the neighbor base station corresponding to the shortest calculated distance value, to the serving base station.

19. The mobile terminal of claim 16, wherein the control layer calculates the distance value (r) between the mobile terminal and each of the neighbor base stations by an equation shown below:
$$r = \frac{λ}{4 π} \cdot \sqrt{\frac{{P}_{T} \cdot {G}_{T} \cdot {G}_{R}}{{P}_{R}}}$$
wherein P_{T} is transmission power of a corresponding neighbor base station, G_{T} is a transmitting antenna gain of the corresponding neighbor base station, and G_{R} is a receiving antenna gain of the mobile terminal.

20. The mobile terminal of claim 16, wherein the message includes information of a single neighbor base station.

21. The mobile terminal of claim 16, wherein the message includes information of at least two neighbor base stations.
